(19) United States
(12) Patent Application Publication
(10) Pub. No.: US 2005/0178035 A1
(43) Pub. Date: Aug. 18, 2005

(54) Address sign assembly

(75) Inventor: Greg A. Csercse, Saginaw, MI (US)

Correspondence Address: King & Jovanovic, PLC, 170 College Avenue, SUITE 230, HOLLAND, MI, 49423, US

(73) Assignee: Creative Frames & Pictures, Inc. d/b/a Creative Products

(21) Appl. No.: 11/101,775

(22) Filed: Apr. 8, 2005

Related U.S. Application Data
(63) Continuation-in-part of application No. 10/901,005, filed on Jul. 28, 2004.
(60) Provisional application No. 60/490,476, filed on Jul. 28, 2003.

(51) Int. Cl. G09F 15/02; G09F 15/00

(52) U.S. Cl. 40/607.09

(57) ABSTRACT

An address sign assembly, comprising: (a) a post, wherein the post comprises a bottom, ground-engaging portion, a top, non-ground-engaging portion, and a mid-portion positioned between the bottom, ground-engaging portion and the top, non-ground-engaging portion of the post; (b) a crown, wherein the crown is associated with the top, non-ground-engaging portion of the post; (c) an arm sub-assembly, wherein the arm sub-assembly comprises: (1) a side member, wherein the side member is secured to the mid-portion of the post in a substantially parallel orientation relative to the post; (2) a base member, wherein the base member emanates contiguously from the side member at a substantially ninety degree angle therefrom; and (3) a decorative member, wherein the decorative member emanates contiguously from the side member and the base member; and (d) a sign associated with the base member of the arm sub-assembly.

### CROSS REFERENCE TO RELATED APPLICATION(S)

This application is a continuation-in-part of co-pending U.S. patent application Ser. No. 10/901,005 entitled “Reflective Address Sign,” filed Jul. 28, 2004, which claims the benefit of U.S. Provisional Patent Application Ser. No. 60/490,476 entitled “Reflective Address Sign,” filed Jul. 28, 2003, which are hereby incorporated herein by reference in their entirety.

### BACKGROUND OF THE INVENTION

1. Field of the Invention

The present invention relates in general to an address sign assembly, and more particularly, to a reflective address sign assembly which comprises components which are easily, securely, and releasably attachable thereto.

2. Background Art

Address signs have been known in the art for several years. Typically, address signs are utilized proximate houses, cottages, and other residential or commercial buildings for purposes of identification. As such, address signs are often placed outside and are therefore subject to a variety of weather conditions and the decline, decay, and/or deterioration that may naturally result. Therefore, an address sign assembly having easily replaceable components is highly desirous.

In addition, address signs typically comprise permanent assemblies which are constructed specifically for a particular address. For example, the address indicated on the sign may be engraved, painted, or otherwise permanently affixed thereto. As such, in the event that a party is leaving the dwelling or building where the address sign has been utilized, the address sign, bearing the former address, becomes obsolete. Accordingly, it is an object of the present invention to overcome the deficiencies of the prior art and to satisfy the commercial demand for an address sign assembly having easily replaceable address indicia.

Address signs are also ornamental by nature. Often, it is desirous that such an address sign be indicative of not only the address, but the season and/or hobby or mood of the party using the address sign. As such, there remains a commercial demand for an address sign assembly which comprises a variety of interchangeable decoration, ornamentation, and/or indicia which can be easily, securely, and releasably attached to the address sign assembly.

These and other objects of the present invention will become apparent in light of the present specification, claims, and drawings.

### SUMMARY OF THE INVENTION

The present invention is directed to an address sign assembly, comprising: (a) a post, wherein the post comprises a bottom, ground-engaging portion, a top, non-ground-engaging portion, and a mid-portion positioned between the bottom, ground-engaging portion and the top, non-ground-engaging portion of the post; (b) a crown, wherein the crown is associated with the top, non-ground-engaging portion of the post; (c) an arm sub-assembly, wherein the arm sub-assembly comprises: (1) a side member, wherein the side member is secured to the mid-portion of the post in a substantially parallel orientation relative to the post; (2) a base member, wherein the base member emanates contiguously from the side member at a substantially ninety degree angle therefrom; and (3) a decorative member, wherein the decorative member emanates contiguously from the side member and the base member; and (d) a sign associated with the base member of the arm sub-assembly.

In a preferred embodiment of the present invention, the post further comprises a pointed tap proximate the bottom, ground-engaging portion.

In another preferred embodiment of the present invention, the crown comprises a threaded base which secures the crown to the top, non-ground-engaging portion of the post.

In yet another preferred embodiment, the mid-portion of the post further comprises at least one aperture; the side member of the arm sub-assembly further comprises at least one aperture; and the address sign assembly further comprises at least one fastener which secures the side member of the arm sub-assembly to the mid-portion of the post through the apertures thereof. In this embodiment, preferably, the at least one fastener releasably secures the side member of the arm sub-assembly to the mid-portion of the post through the apertures thereof.

In a preferred embodiment of the present invention, the sign further comprises: (a) a first face; (b) a second face; and (c) at least one indicia associated with at least one of the first face and the second face. In this embodiment, preferably, the at least one indicia is releasably associated with at least one of the first face and the second face and at least one of the at least one indicia comprises a reflective material.

In another preferred embodiment, the sign further comprises at least one aperture having a ring therethrough which is securable to the base member of the arm sub-assembly.

In a further preferred embodiment of the present invention, the at least one aperture comprises a ring therethrough which is releasably securable to the base member of the arm sub-assembly.

The present invention is also directed to an address sign assembly, comprising: (a) a post, wherein the post comprises a bottom, ground-engaging portion, a top, non-ground-engaging portion, and a mid-portion between the bottom, ground-engaging portion and the top, non-ground-engaging portion having at least one aperture; (b) a crown, wherein the crown is associated with the top, non-ground-engaging portion of the post; (c) an arm sub-assembly, wherein the arm sub-assembly comprises: (1) a side member, wherein the side member comprises at least one aperture and is secured to the at least one aperture of the mid-portion of the post via at least one fastener in a substantially parallel orientation relative to the post; (2) a base member, wherein the base member emanates contiguously from the side member at a substantially ninety degree angle therefrom; and (3) a decorative member, wherein the decorative member emanates contiguously from the side member and the base member; and (d) a sign, wherein the sign comprises: (1) a first face; (2) a second face; (3) at least one indicia associated with at least one of the first face and the second face; and (4) at least one aperture having a ring therethrough which is securable to the base member of the arm sub-assembly.

In a preferred embodiment of the present invention, the post further comprises a pointed tap proximate the bottom, ground-engaging portion.

In another preferred embodiment of the present invention, the crown comprises a threaded base which secures the crown to the top, non-ground-engaging portion of the post.

In yet another preferred embodiment, the at least one fastener releasably secures the side member of the arm sub-assembly to the mid-portion of the post through the apertures thereof.

In a further preferred embodiment, the at least one indicia is releasably associated with at least one of the first face and the second face, and, preferably, at least one of the at least one indicia comprises a reflective material.

In another preferred embodiment, the at least one aperture comprises a ring therethrough which is releasably securable to the base member of the arm sub-assembly.

The present invention is also directed to an address sign assembly, consisting of: (a) a post, wherein the post comprises a bottom, ground-engaging portion, a top, non-ground-engaging portion, and a mid-portion between the bottom, ground-engaging portion and the top, non-ground-engaging portion having at least one aperture, wherein the post further comprises a pointed tap proximate the bottom, ground-engaging portion; (b) a crown, wherein the crown is associated with the top, non-ground-engaging portion of the post; (c) an arm sub-assembly, wherein the arm sub-assembly comprises: (1) a side member, wherein the side member comprises at least one aperture and is releasably secured to the at least one aperture of the mid-portion of the post via at least one fastener in a substantially parallel orientation relative to the post; (2) a base member, wherein the base member emanates contiguously from the side member at a substantially ninety degree angle therefrom; and (3) a decorative member, wherein the decorative member emanates contiguously from the side member and the base member; and (d) a sign, wherein the sign comprises: (1) a first face; (2) a second face; (3) at least one indicia releasably associated with at least one of the first face and the second face, wherein the at least one indicia comprises a reflective material; and (4) at least one aperture having a ring therethrough which is releasably securable to the base member of the arm sub-assembly.

### BRIEF DESCRIPTION OF THE DRAWINGS

The invention will now be described with reference to the drawings wherein:

FIG. 1 of the drawings is a right perspective view of a first embodiment of an address sign assembly fabricated in accordance with the present invention;

FIG. 2 of the drawings is a left perspective view of a first embodiment of an address sign assembly fabricated in accordance with the present invention;

FIG. 3 of the drawings is a fragmented, right perspective view of a first embodiment of an address sign assembly fabricated in accordance with the present invention;

FIG. 4 of the drawings is a fragmented, right perspective view of a first embodiment of an address sign assembly fabricated in accordance with the present invention;

FIG. 5 of the drawings is a top perspective view of a first embodiment of an address sign assembly fabricated in accordance with the present invention;

FIG. 6 of the drawings is a bottom perspective view of a first embodiment of an address sign assembly fabricated in accordance with the present invention; and

FIG. 7 of the drawings is a perspective view of a first embodiment of decals for use in association with an address sign assembly fabricated in accordance with the present invention.

### DETAILED DESCRIPTION OF THE INVENTION

While this invention is susceptible of embodiment in many different forms, there is shown in the drawings and will herein be described in detail a specific embodiment with the understanding that the present disclosure is to be considered as an exemplification of the principles of the invention and is not intended to limit the invention to the embodiment illustrated.

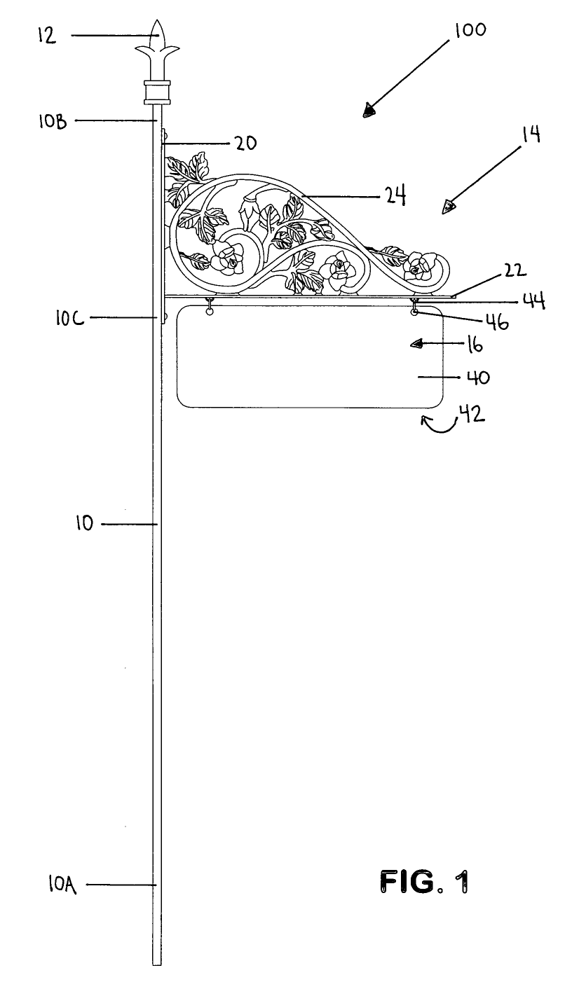

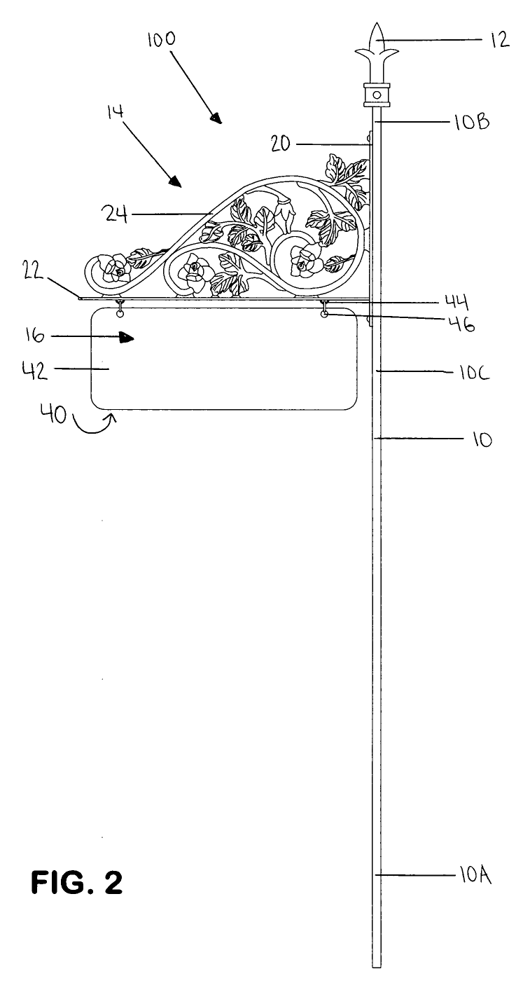

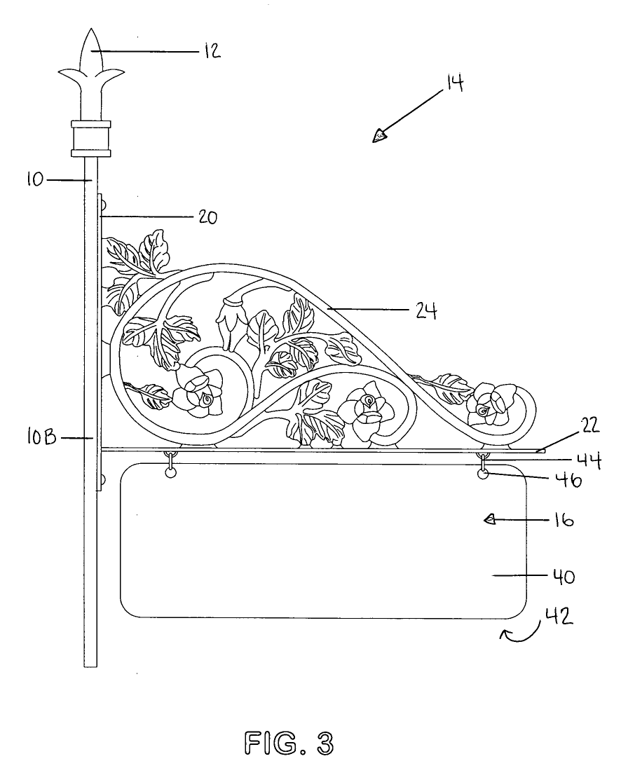

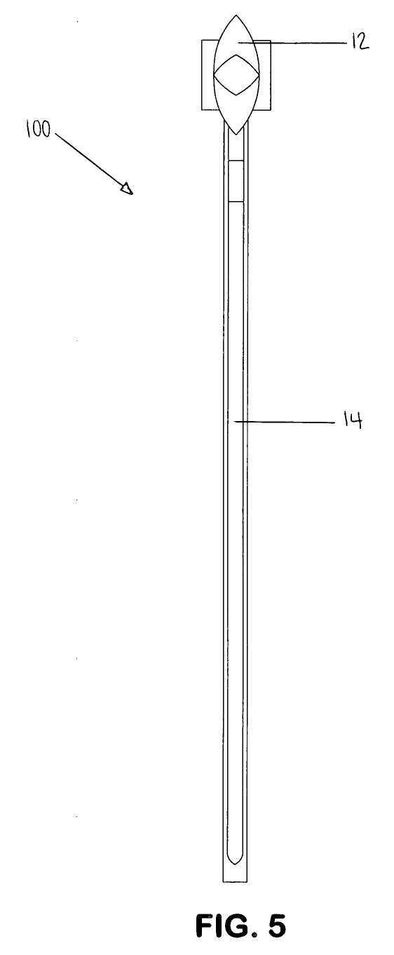

Referring now to the drawings and to FIGS. 1 and 2 in particular, right and left perspective views, respectively, of address sign assembly 100 are shown, which generally comprise post 10, crown 12, arm sub-assembly 14, and sign 16. It will be understood that FIGS. 1 through 7 are merely schematic representations of address sign assembly 100. As such, some of the components may have been distorted from their actual scale for pictorial clarity. It will be further understood that address sign assembly 100 may be used for a plurality of applications including house, cottage, and building identification—just to name few. Moreover, it will be understood that address sign assembly 100 may even be used for non-address applications, such as indicating directions and/or points of interest along a nature trail, for example.

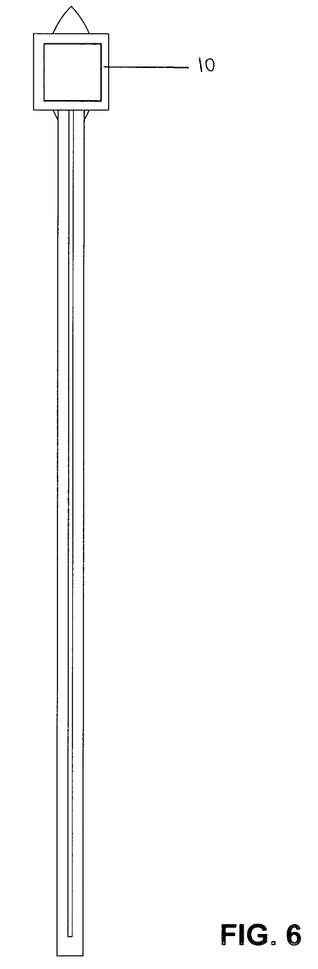

Post 10 includes a bottom, ground-engaging portion 10A, a top, non-ground-engaging portion 10B, and a mid-portion 10C between bottom, ground-engaging portion 10A and top, non-ground-engaging portion 10B. After a typical installation, post 10 is configured to emanate substantially vertically from the ground. While post 10 is shown, for illustrative purposes only, as being fabricated from metal, it will be understood that post 10 may be fabricated from any one of a number of materials including numerous metals and alloys, plastics, woods, etcetera. As is shown in FIG. 6, post 10 is hollow, however, it will be understood that post 10 may also comprise a non-hollow, solid cross-section. Moreover, although not shown, post 10 may include a pointed tap proximate bottom, ground-engaging portion 10A to facilitate easy installation of post 10 into the ground.

Crown 12 is mounted proximate non-ground engaging portion 10B of post 10, and serves to, among other things, provide a decorative finish to address sign assembly 100. While crown 12 is shown, for illustrative purposes only, as being fabricated from plastic, it will be understood that crown 12 may be fabricated from any one of a number of materials including numerous metals and alloys, plastics, woods, etcetera. Crown 12 may comprise a threaded base which may screw into top, non-ground-engaging portion 10B of post 10 for releasable securement of the crown therein. However, alternate means of securement for crown 12 are also contemplated, including releasable and permanent securement means, such as compression fit or welding.

As can be seen in FIGS. 1 through 4, collectively, arm sub-assembly 14 is shown as comprising a side member 20, a base member 22, and a decorative member 24.

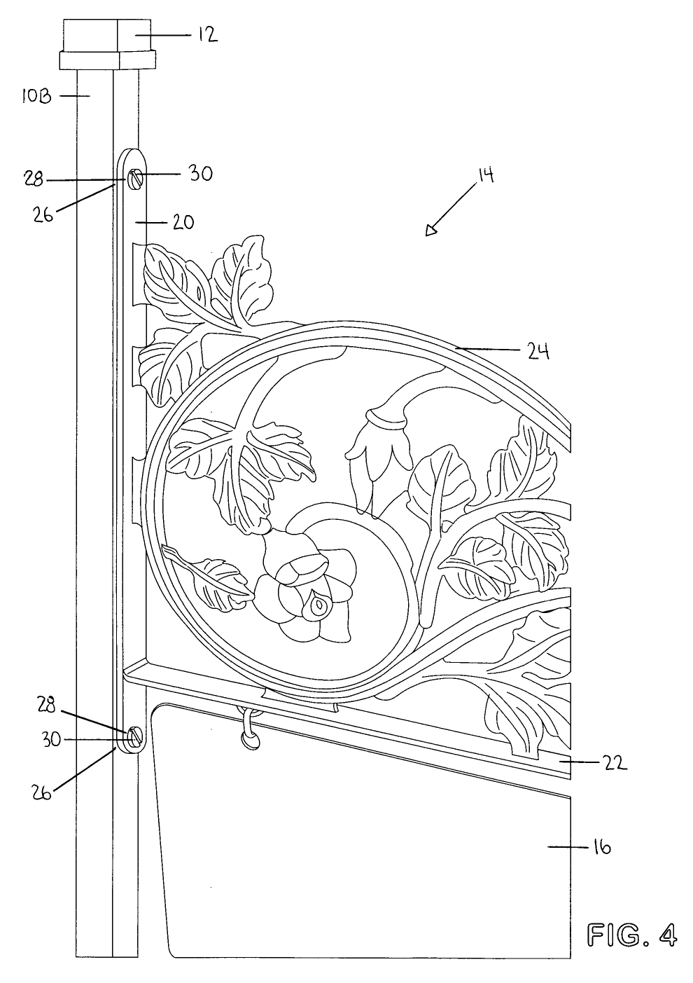

Side member 20 of arm sub-assembly 14 is mounted to mid-portion 10C of post 10, preferably proximate non-ground engaging portion 10B, in a substantially parallel orientation relative to post 10. As is shown in FIG. 4, securement thereof may be achieved via at least one aperture 26 on mid-portion 10C of post 10, at least one aperture 28 on side member 20 which aligns with at least one aperture 26, and at least one fastener 30 which secures side member 20 to mid-portion 10C through apertures 26 and 28 thereof, respectively. As FIG. 4 indicates, preferably, mid-portion 10C comprises two apertures 26 which align with two apertures 28 on side member 20. In this embodiment, at least one fastener 30 comprises two fasteners 30 for fitment within apertures 26 and 28. At least one fastener 30 may comprise a threaded fastener(s) and may releasably secure side member 20 to mid-portion 10C of post 10 through the apertures thereof. Of course, other fastening means are likewise contemplated for use, including, but not limited to, non-threaded fasteners, rivets, various tapes, adhesives—just to name a few.

Base member 22 of arm sub-assembly 14 emanates contiguously from side member 20 at a substantially ninety degree angle therefrom. Preferably, base member 22 emanates contiguously from side member 20 between two apertures 28 for purposes of stability.

Decorative member 24 of arm sub-assembly 14 emanates contiguously from side member 20 and base member 22. While decorative member 24 is shown in FIGS. 1 through 4 as emanating contiguously from side member 20 at a plurality of sites and from base member 22 at a plurality of sites, it will be understood that decorative member 24 may emanate therefrom at a single site or, alternatively, at any number of sites. Furthermore, while decorative member 24 is shown in FIGS. 1 through 4 as comprising a specific, linear design, it will be understood that decorative member 24 may comprise any design and may be linear or multi-dimensional.

While arm sub-assembly 14 is shown, for illustrative purposes only, as being fabricated from plastic, it will be understood that arm sub-assembly 14 may be fabricated from any one of a number of materials including numerous metals and alloys, plastics, woods, etcetera. Furthermore, while arm sub-assembly 14 is shown as comprising a unitary member made up of members 20, 22, and 24, it will be understood that members 20, 22, and 24 may comprise separate members comprising the same or different materials, which are fused, welded, fastened, or otherwise attached.

As is best shown in FIGS. 1 through 4, collectively, sign 16 comprises first face 40, second face 42, and at least one openable fastener 44 which attaches sign 16 to arm sub-assembly 14 via engagement thereof. It will be understood that sign 16 emanates contiguously downward from arm sub-assembly 14. At least one openable fastener 44 may comprise at least one ring releasably securable within an aperture 46 of sign 16 and to base member 22 or an aperture therein. Preferably, and as is shown in FIGS. 1 through 4, at least one openable fastener 44 comprises two rings 44 which are releasably securable within two apertures 46 of sign 16 and to base member 22 or an aperture therein. Although not shown, it is further contemplated that an additional openable fastener 44 may attach sign 16 to post 10 via engagement thereof for further stability of sign 16. Of course, other fastening means are likewise contemplated for use, including, but not limited to, non-openable fasteners, threaded fasteners, non-threaded fasteners, rivets, various tapes, adhesives—just to name a few. While sign 16 is shown, for illustrative purposes only, as being fabricated from metal, it will be understood that sign 16 may be fabricated from any one of a number of materials including numerous metals and alloys, plastics, woods, etcetera. Furthermore, while sign 16 is shown in FIGS. 1 through 4 as comprising a linear, rectangular shape, it will be understood that sign 16 may comprise any one of a number of different shapes, such as circular, square, triangular, polygonal, or arbitrary, and may be linear or multi-dimensional.

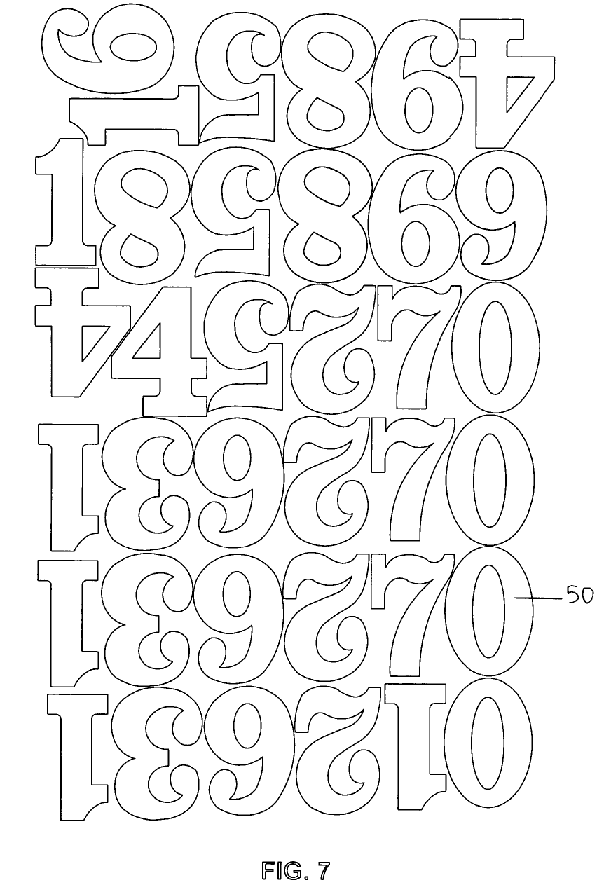

As is shown in FIG. 7, at least one indicia 50 can be associated with at least one of first face 40 and second face 42 of sign 16, to personalize address sign assembly 100. Indicia 50 may comprise reflective, alpha-numeric decals and may be releasably or permanently affixed to sign 16. Of course, the indicia/decals utilized may be selected from any one of a number of symbols—so long as the symbols are capable of distinguishing a particular location from another.

While address sign assembly 100 has been shown as being directly attached to post 10, it will be understood that arm sub-assembly 14 and sign 16 may be mounted directly to, for example, a tree, building, or other structure, without utilizing post 10.

The foregoing description merely explains and illustrates the invention and the invention is not limited thereto except insofar as the appended claims are so limited, as those skilled in the art who have the disclosure before them will be able to make modifications without departing the scope of the invention.

1. An address sign assembly, comprising:
a post, wherein the post comprises a bottom, ground-engaging portion, a top, non-ground-engaging portion, and a mid-portion positioned between the bottom, ground-engaging portion and the top, non-ground-engaging portion of the post;
a crown, wherein the crown is associated with the top, non-ground-engaging portion of the post;
an arm sub-assembly, wherein the arm sub-assembly comprises:
a side member, wherein the side member is secured to the mid-portion of the post in a substantially parallel orientation relative to the post;
a base member, wherein the base member emanates contiguously from the side member at a substantially ninety degree angle therefrom; and
a decorative member, wherein the decorative member emanates contiguously from the side member and the base member; and
a sign associated with the base member of the arm sub-assembly.

2. The address sign assembly according to claim 1, wherein the post further comprises a pointed tap proximate the bottom, ground-engaging portion.

3. The address sign assembly according to claim 1, wherein the crown comprises a threaded base which secures the crown to the top, non-ground-engaging portion of the post.

4. The address sign assembly according to claim 1, wherein:
the mid-portion of the post further comprises at least one aperture;
the side member of the arm sub-assembly further comprises at least one aperture; and
the address sign assembly further comprises at least one fastener which secures the side member of the arm sub-assembly to the mid-portion of the post through the apertures thereof.

5. The address sign assembly according to claim 4, wherein the at least one fastener releasably secures the side member of the arm sub-assembly to the mid-portion of the post through the apertures thereof.

6. The address sign assembly according to claim 1, wherein the sign further comprises:
a first face;
a second face; and
at least one indicia associated with at least one of the first face and the second face.

7. The address sign assembly according to claim 6, wherein the at least one indicia is releasably associated with at least one of the first face and the second face.

8. The address sign assembly according to claim 6, wherein at least one of the at least one indicia comprises a reflective material.

9. The address sign assembly according to claim 1, wherein the sign further comprises at least one aperture having a ring therethrough which is securable to the base member of the arm sub-assembly.

10. The address sign assembly according to claim 9, wherein the at least one aperture comprises a ring therethrough which is releasably securable to the base member of the arm sub-assembly.

11. An address sign assembly, comprising:
a post, wherein the post comprises a bottom, ground-engaging portion, a top, non-ground-engaging portion, and a mid-portion between the bottom, ground-engaging portion and the top, non-ground-engaging portion having at least one aperture;
a crown, wherein the crown is associated with the top, non-ground-engaging portion of the post;
an arm sub-assembly, wherein the arm sub-assembly comprises:
a side member, wherein the side member comprises at least one aperture and is secured to the at least one aperture of the mid-portion of the post via at least one fastener in a substantially parallel orientation relative to the post;
a base member, wherein the base member emanates contiguously from the side member at a substantially ninety degree angle therefrom; and
a decorative member, wherein the decorative member emanates contiguously from the side member and the base member; and
a sign, wherein the sign comprises:
a first face;
a second face;
at least one indicia associated with at least one of the first face and the second face; and
at least one aperture having a ring therethrough which is securable to the base member of the arm sub-assembly.

12. The address sign assembly according to claim 11, wherein the post further comprises a pointed tap proximate the bottom, ground-engaging portion.

13. The address sign assembly according to claim 11, wherein the crown comprises a threaded base which secures the crown to the top, non-ground-engaging portion of the post.

14. The address sign assembly according to claim 11, wherein the at least one fastener releasably secures the side member of the arm sub-assembly to the mid-portion of the post through the apertures thereof.

15. The address sign assembly according to claim 11, wherein the at least one indicia is releasably associated with at least one of the first face and the second face.

16. The address sign assembly according to claim 11, wherein at least one of the at least one indicia comprises a reflective material.

17. The address sign assembly according to claim 11, wherein the at least one aperture comprises a ring therethrough which is releasably securable to the base member of the arm sub-assembly.

18. An address sign assembly, consisting of:
a post, wherein the post comprises a bottom, ground-engaging portion, a top, non-ground-engaging portion, and a mid-portion between the bottom, ground-engaging portion and the top, non-ground-engaging portion having at least one aperture, wherein the post further comprises a pointed tap proximate the bottom, ground-engaging portion;
a crown, wherein the crown is associated with the top, non-ground-engaging portion of the post;
an arm sub-assembly, wherein the arm sub-assembly comprises:
a side member, wherein the side member comprises at least one aperture and is releasably secured to the at least one aperture of the mid-portion of the post via at least one fastener in a substantially parallel orientation relative to the post;
a base member, wherein the base member emanates contiguously from the side member at a substantially ninety degree angle therefrom; and
a decorative member, wherein the decorative member emanates contiguously from the side member and the base member; and
a sign, wherein the sign comprises:
a first face;
a second face;
at least one indicia releasably associated with at least one of the first face and the second face, wherein the at least one indicia comprises a reflective material; and
at least one aperture having a ring therethrough which is releasably securable to the base member of the arm sub-assembly.
